(19) United States
(12) Patent Application Publication
(10) Pub. No.: US 2015/0345982 A1
(43) Pub. Date: Dec. 3, 2015

(54) METHOD FOR MOVING IMAGE CONTENTS DISPLAYED ON A DISPLAY DEVICE OF A VEHICLE, OPERATOR CONTROL AND DISPLAY DEVICE FOR A VEHICLE AND COMPUTER PROGRAM PRODUCT

(71) Applicant: DAIMLER AG, Stuttgart (DE)

(72) Inventor: Christian SCHMITT, Stuttgart (DE)

(73) Assignee: Daimler AG, Stuttgart (DE)

(21) Appl. No.: 14/759,730

(22) PCT Filed: Dec. 21, 2013
(86) PCT No.: PCT/EP2013/003935

§ 371 Date: Jul. 8, 2015

(30) Foreign Application Priority Data
Jan. 9, 2013 (DE) 10 2013 000 272.9

(51) Int. Cl. G01C 21/36; G06F 3/0482; G06F 3/0484; G06F 3/0485; G06F 3/0488

(52) U.S. Cl. CPC G01C 21/3664; G06F 3/0485; G06F 3/0488; G06F 3/04847; G06F 3/0482; G06F 3/04845

(57) ABSTRACT

A method for moving image contents that are displayed on a display device of a motor vehicle is disclosed. A movement of the image content takes place by user input on a touch-sensitive surface differing from the display device. The user input involves touching the touch-sensitive surface with a finger on a first point, movement of the finger over the touch-sensitive surface from the first point to a second point, and holding the finger on the second point during the movement of the image content. A direction in which the image content is moved is based on a relative position of the second point in relation to the first point. A distance from the second point to the first point determines a speed at which the image content is moved. A corresponding control and display device and computer program product are also disclosed.

### BACKGROUND AND SUMMARY OF THE INVENTION

The present invention relates to a method for moving image content displayed on a display device of a motor vehicle, a control and display device for a motor vehicle and a computer program product.

It is known from the prior art to display image content, for example maps, on a screen in a motor vehicle. The image content can be shifted in order to display an area lying outside of the displayed map section on the screen. Mobile navigation devices ordinarily have a touch-sensitive screen (touchscreen), upon which the map can be moved by means of swiping motions which are executed by a finger of the user. However, navigation devices integrated into the motor vehicle display the maps on a screen of the motor vehicle, which often is not designed as a touchscreen, in order to achieve the longest possible functional life of the screen. Different control elements can be used to control the display of the image content, for example a central control element, which for example can be a turn and press controller or a touch-sensitive surface, i.e., a touchpad, which is separate from the screen.

A touch-based control system for a display device in a motor vehicle is known from DE 10 2009 048 622 A1. Movement of a map displayed on a screen of the motor vehicle can be implemented by different methods. For example, the map can be moved by having a finger of the user touch a touch-sensitive surface at a first point and then the user moves the finger to a border of the touch-sensitive surface. If the finger of the user remains on the border of the touch-sensitive surface for a predetermined time, the map will move in a direction that is predefined by a position of the finger on the border of the touch-sensitive surface. The map stops moving when the finger of the user is removed from the touch-sensitive surface.

The object of the present invention is to create a method, a control and display device and a computer program product for an application in a motor vehicle, which permits a free, flexible and continuous movement of image content displayed on a display device of a motor vehicle.

According to one method, a touch-based control system is used for a display device in a motor vehicle with a touch-sensitive surface differing from the display device. Image contents that are displayed on the display device of the motor vehicle are moved by means of user input on the touch-sensitive surface. The user input for moving the image content features the touching of the touch-sensitive surface with an object or finger on a first point, from which the finger is moved over the touch-sensitive surface to a second point, at which the finger is held during the moving of the image content. In the process, the direction in which the image content is moved is not predefined by an absolute position of the second point on the touch-sensitive surface, but rather by the relative position of the second point in reference to the first point of contact. The speed at which the image content is moved is determined by the distance of the second point to the first point. Thus, the user can freely move the image content progressively in any direction and at any speed. Thus, a slight distance between the starting point and end point can trigger a slow movement if the image content does not have to be moved too far, and a great distance can trigger a rapid movement if the image content has to be moved far.

During user input, a cross-hair pointer and an arrow display are superimposed on the image content that is shown on the display device, wherein the arrow display follows the movement of the finger over the touch-sensitive surface from the first point to the second point. The arrow direction of the arrow display in relation to a center of the cross-hair pointer indicates the direction in which the image content is moved, and the distance of the arrow display to the cross-hair pointer indicates the speed at which the image content is moved. The arrow display during the movement of the finger gives the user feedback, with which the user can orient himself or herself on the touch-sensitive surface, in order to make the most precise settings for the desired direction and speed of the movement with the placement of the finger at the second point, at which it stays.

The movement of the image content advantageously starts only when the finger is held at the second position for a predetermined time. Therefore, the user can select the precise direction and speed which are communicated to the user via the arrow display, before the image content is moved.

The movement of the image content after removal of the finger from the second point on the touch-sensitive surface is preferably not ended abruptly, but rather by a uniform reduction in the speed of the movement. Above all in the case of greater speeds, the user can remove the user's finger from the touch-sensitive surface before the desired image section can be seen on the display device, so that by slowing down the movement the user either gets the desired image content or can get the user's bearings as to how far and whether the user has moved the image content in the correct direction. Depending on whether the user has obtained the desired image content on the display or not, the user can then initiate further user input in the same or in a divergent direction. The speed at which the movement is executed can be correspondingly reset after orientation: slow movement for close image content and faster movement for image content that is further away.

In order to prevent an accidental movement of the image content, for example when the finger is shaky or wobbly on the touch-sensitive surface in the event of turbulent driving of the motor vehicle, a minimum distance can be defined by which the second point must be spaced apart from the first point in order to initiate an overlay of the arrow display or the movement of the image content.

The speed at which the image content is moved can be increased linearly or non-linearly when the distance of the second point to the first point increases.

The method can be provided to move a map of a navigation system as image content. However, the method can likewise be used to move other image contents that appear on the display device.

The described method for moving the image content by touchpad operation cancels out the conflict of the user from the user's expectations that arise from the usual operation of a touchscreen and the actual structure of the control element: In contrast to the touchscreen, in the case of the use of a touchpad separate from a display screen as a control element there is a conflict between the operating modes “Movement of the cursor (Cross-hair pointer)” or “Movement of the image content (Map)”. Furthermore, a conflict with conventional methods, for example scrolling by means of a central control element, is also avoided.

In the following, the present invention will be described in greater detail with the assistance of an exemplary embodiment referring to the attached drawings. Identical or similar objects or parts are consistently marked with the same reference numerals in the various views.

### BRIEF DESCRIPTION OF THE DRAWINGS

FIG. 1 shows exemplary end contact points on a touchpad with an indicated speed of movement, which is dependent on a distance of a respective end contact point to a starting contact point;

FIG. 2 shows additional exemplary end contact points on the touchpad with the indicated speed of movement, which is dependent on a distance of a respective end contact point to another starting contact point; and

FIG. 3 shows map views a) through c) with a cross-hair pointer and an arrow display in the case of a selection of the direction of movement and speed of movement (a) and b)) and in the case of a movement of the map view (c)).

### DETAILED DESCRIPTION OF THE DRAWINGS

In the case of a touch-based control system, the movement of an image content, for example of a map on a motor vehicle screen, is carried out with a touch-sensitive surface as a control element, for example a touchpad, such that, depending on a first point of contact of a finger on the touch-sensitive surface, as long as the finger is moved on the touch-sensitive surface, every other contact point of the finger on the touch-sensitive surface will be displayed as an arrow on the motor vehicle screen of the motor vehicle, the arrow specifying a direction of movement and speed of movement for moving the image content. Furthermore, a cross-hair pointer will be superimposed over the image content on the motor vehicle screen. A position of the arrow in relation to a center of the cross-hair pointer indicates the direction of movement and a distance of the arrow from the cross-hair pointer indicates the speed of movement.

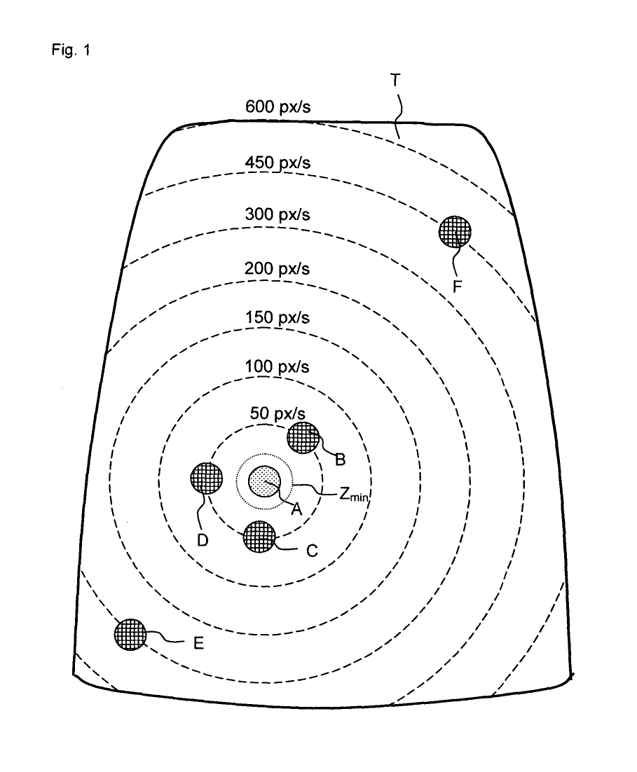

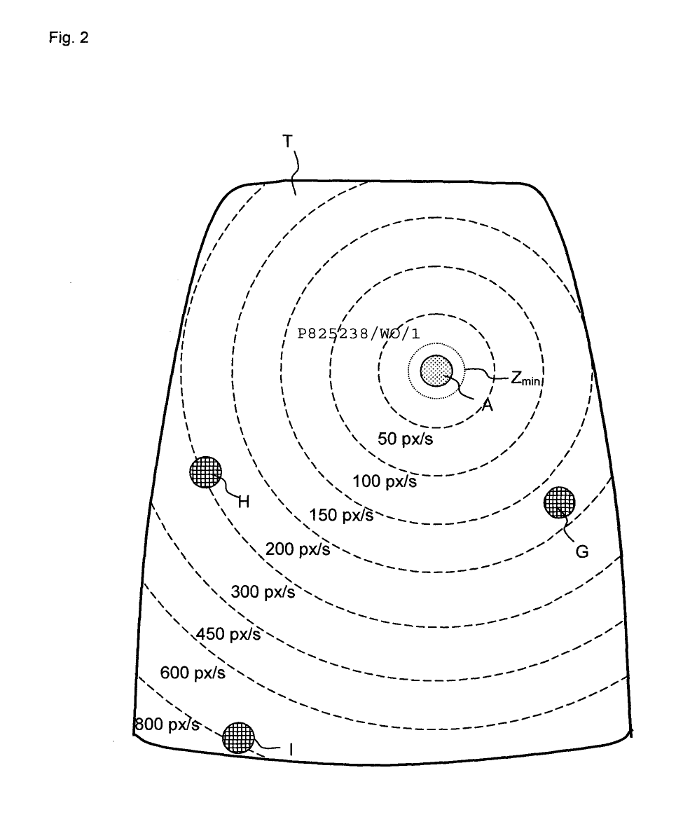

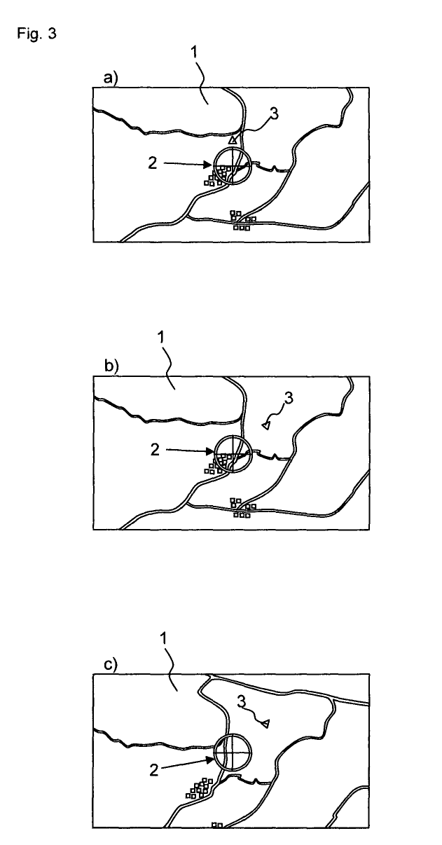

FIG. 1 and FIG. 2 each show a touchpad T as a touch-sensitive surface, with which the movement of an image content, for example of a map 1 (see FIG. 3 a through c) can be controlled.

A circle A in FIGS. 1 and 2 symbolizes the first point of contact, proceeding from which the finger is moved over the touchpad T in order to set the desired direction of movement and speed. A dotted circumference Zmin, which cannot be seen on a real touchpad T, illustrates a minimum distance that the finger must move proceeding from the first contact point A, in order to initiate a movement of the image content. Dashed circumferences around Point A also cannot be seen on a real touchpad T; they serve only to illustrate the speed of movement in pixels per second (px/s) depending on the distance to the first contact point A. In the examples presented in FIGS. 1 and 2, the speed increases partially linearly (here up to a radius corresponding to Point E up to 200 px/s) and partially non-linearly with the distance to the first point of contact A. Depending on the size of the touchpad and the resolution of the screen, the values of the speeds of movement and their increase can deviate from the presented examples depending on the distance of a second point of contact from the first point of contact.

The circles B,C,D,E,F in FIG. 1 and G,H,I in FIG. 2 are random points at which the finger touches the touchpad T after the first point of contact A. The respective location of the points B,C,D,E,F and G,H,I in reference to the first point of contact A determines in each case the direction of movement and speed of movement of the image content on the display device when the finger remains on the corresponding point. The direction of movement in the process does not depend on a predefined point of contact on a border of the touchpad, but rather can be freely selected proceeding from any starting position. Thus in FIG. 1 the starting point A lies in the lower left quarter of the touchpad T, and in FIG. 2 in the upper right quarter.

The points of contact B,C,D to be seen in FIG. 1, when they are selected as end points for moving the image content, i.e., as second points of contact, set a speed of movement of 50 px/s, though in differing directions. If the point of contact B is selected as an end point, the image content should be moved at the mentioned speed of movement to the northeast; this corresponds to a shift of 50 px/s to the north and 50 px/s to the east or in the corresponding Cartesian x,y coordinate system of the screen. The point of contact C as the end point causes a shift of the image content to the south and the point of contact D as the end point a shift to the west with 50 px/s in each case.

With Point E as the end contact point, the image content is moved in a south-westerly direction at a speed of 200 px/s, to be more precise at 150 px/s to the south and 125 px/s to the west. If Point F is selected as the end contact point, the image content will move at 280 px/s to the north and 180 px/s to the east, which corresponds to a shift in a north-eastern direction with 450 px/s. The division of the speed of movement in a specified direction into the associated displacement vectors in the x,y coordinate system is known to persons skilled in the art in graphics and animation programming.

Depending on the location of the starting point A on the touchpad T, different maximum speeds can be achieved. Thus, in the example presented in FIG. 2 with the starting point A in the upper right quarter of the touchpad, a speed of movement to the southwest of 800 px/s (with End point I) can be achieved (corresponding to 620 px/s to the south and 195 px/s to the west). If greater speeds of movement are to be achieved in other directions, the starting contact point should be selected correspondingly, for example on the lower end of the touchpad for a rapid shift of the image content to the north. Points G and H as end points cause a shift in southeastern direction with 175 px/s (125 px/s south and 115 px/s east) or in a southwestern-western direction with 300 px/s (95 px/s south and 225 px/s west).

FIG. 3 illustrates in a) and b), by way of example, a display of a map 1 as image content on a motor vehicle screen during the selection of the direction of movement and the speed of movement. After the user has touched the touchpad on the first point of contact, the cross-hair pointer 2 and the arrow display 3 appear when he has moved his finger away from the first point of contact at least by the minimum distance on the touchpad. Arrow 3 in FIG. 3a), which points to the north and is only at a short distance from the cross-hair pointer, corresponds to a second point of contact somewhat above the starting contact point and, as an end point, would result in a shift of the map to the north at low speed. In the present example, this is not the intention, so that the user moves his finger further on the touchpad until he has placed the arrow display 3 as shown in FIG. 3b). In the process, the arrow display 3 points to the northeast, the direction in which the user would like to move the map 1. The (in comparison to FIG. 3a) greater distance of the arrow display 3 to the cross-hair pointer 2 determines the speed of movement at which the map is shifted to the northeast corresponding to the arrow display 3. If the finger remains on the selected point of contact, the map 1 begins shifting in the selected direction and at the selected speed. FIG. 3c) shows the map display after the map begins shifting in a northeastern direction.

As long as the finger on the touchpad remains on the end contact point, the image content continues shifting. When the finger is removed from the touch-sensitive surface, the movement of the image content on the motor vehicle display slows down uniformly.

The previously described exemplary embodiment can be implemented as a computer program product, such as for example a storage medium that is designed to execute a method according to the foregoing exemplary embodiment in cooperation with one computer or several computers, that is computer systems, or other processing units. The computer program product can be designed to execute the method only after carrying out a predetermined routine, for example such as a setup routine.

Although the present invention has been described in the foregoing with the assistance of an exemplary embodiment, it should be understood that different embodiments and modifications can be carried out without abandoning the scope of the present invention, as it is defined in the attached claims.

With respect to additional features and advantages of the present invention, attention is explicitly drawn to the disclosure of the drawings.

1.-11. (canceled)

12. A method for moving image content displayed on a display device of a motor vehicle, comprising the steps of:
moving the image content displayed on the display device in response to a touching of a touch-sensitive surface that differs from a display surface of the display device with an object on a first point and moving the object over the touch-sensitive surface from the first point to a second point;
determining a direction of movement of the image content on a basis of a relative position of the second point in relation to the first point; and
determining a speed of movement of the image content on a basis of a distance from the second point to the first point.

13. The method according to claim 12, further comprising the steps of:
displaying a cross-hair pointer and an arrow display superimposed on the image content; and
moving the arrow display in response to the moving of the object over the touch-sensitive surface, wherein an arrow direction of the arrow display in relation to a center of the cross-hair pointer displays the direction of movement of the image content and a distance of the arrow display to the center of the cross-hair pointer displays the speed of movement of the image content.

14. The method according to claim 12, further comprising the step of beginning the moving of the image content after the object touches the touch-sensitive surface on the second point for a predetermined time.

15. The method according to claim 12, further comprising the step of ending the moving of the image content in response to an ending of touching the touch-sensitive surface on the second point by the object.

16. The method according to claim 15, wherein the ending of the moving of the image content includes a uniform reduction in the speed of movement of the image content.

17. The method according to claim 12, further comprising the step of beginning the moving of the image content after a distance from the second point to the first point has reached a predetermined minimum distance unequal to zero.

18. The method according to claim 12, wherein the speed of movement of the image content increases linearly or non-linearly with an increasing distance from the second point to the first point.

19. The method according to claim 12, wherein the image content is a map of a motor vehicle navigation system.

20. The method according to claim 12, wherein the object is a finger.

21. A control and display device for a motor vehicle, comprising:
a display device with a display surface; and
a touch-sensitive surface that differs from the display surface of the display device;
wherein an image content displayed on the display device is movable in response to a touching of the touch-sensitive surface with an object on a first point and moving the object over the touch-sensitive surface from the first point to a second point;
wherein a direction of movement of the image content is determinable on a basis of a relative position of the second point in relation to the first point;
and wherein a speed of movement of the image content is determinable on a basis of a distance from the second point to the first point.

22. A non-transitory computer-readable medium for moving image content displayed on a display device of a motor vehicle, wherein the computer-readable medium contains instructions, which when executed by a device, cause the device to:
move the image content displayed on the display device in response to a touching of a touch-sensitive surface that differs from a display surface of the display device with an object on a first point and moving the object over the touch-sensitive surface from the first point to a second point;
determine a direction of movement of the image content on a basis of a relative position of the second point in relation to the first point; and
determine a speed of movement of the image content on a basis of a distance from the second point to the first point.
